(19) United States
(12) Patent Application Publication
(10) Pub. No.: US 2014/0280086 A1
(43) Pub. Date: Sep. 18, 2014

(54) METHOD AND APPARATUS FOR DOCUMENT REPRESENTATION ENHANCEMENT VIA SOCIAL INFORMATION INTEGRATION IN INFORMATION RETRIEVAL SYSTEMS

(71) Applicants: Mohamed Reda Bouadjenek, Massy (FR); Hakim Hacid, Bourg la reine (FR)

(72) Inventors: Mohamed Reda Bouadjenek, Massy (FR); Hakim Hacid, Bourg la reine (FR)

(73) Assignee: Alcatel Lucent, Paris (FR)

(21) Appl. No.: 13/840,180

(22) Filed: Mar. 15, 2013

(51) Int. Cl. G06F 17/30

(52) U.S. Cl. CPC G06F 17/30864
USPC 707/723; 707/722; 707/741

(57) ABSTRACT

A method and system for specific information retrieval on the Web that provides for a better handling of personalized queries are disclosed. An exemplary system includes a social enrichment function configured for enhancing the representation of documents from the Web with social information; a social modeling function configured for modeling the documents from the Web in a personalized way at query time; and/or a document textual content indexer configured for keeping up to date the representation of documents as users contribute one or more types of social context.

### BACKGROUND

This exemplary embodiment relates to a method and apparatus for document representation enhancement via social information integration in information retrieval systems. While the exemplary embodiment is particularly directed to the art of telecommunications, and will be thus described with specific reference thereto, it will be appreciated that the exemplary embodiment may have usefulness in other fields and applications.

By way of background, in existing information retrieval systems, queries are usually interpreted and processed using document indexes and/or ontologies which are hidden to the user. The resulting documents are not necessarily all relevant from an end-user perspective, in spite of their ranking according to their relevance to the user's query and to their importance (popularity) in the document corpus. To improve the information retrieval process and reduce the amount of irrelevant documents, there are mainly three approaches: (i) query reformulation using extra knowledge, i.e., expansion or refinement of the user query, (ii) post-filtering or re-ranking of the retrieved documents (based on the user profile or context), and (iii) improvement of the information retrieval model, i.e., reengineering of the information retrieval process to integrate contextual information and relevant ranking functions.

Modeling in information retrieval is a complex process aimed at producing a ranking function, i.e., a function that assigns scores to documents with regard to a given query. This process generally consists of two main tasks: (i) the conception of a logical framework for representing documents and queries and (ii) the definition of a ranking function that allows quantifying the similarities among documents and queries. Information retrieval systems usually adopt index terms to represent, index and retrieve documents. An index term is, in a restricted sense, a keyword that has some meaning on its own; it usually plays the role of a noun. It can be extracted from: textual content, e.g., any word that appears in a document; metadata, e.g. description, keywords, title, etc.; and/or the social context of the document.

Classical documents representation operates generally with a query oriented view, i.e., how to optimize the representation according to the queries. This means that the representation is generic for all the queries and intends to be more efficient for global queries instead of queries fired by users with their preferences and expectations.

Thus, there is a need for an improved method and system for specific information retrieval that provides for a better handling of personalized queries.

### SUMMARY OF THE EXEMPLARY EMBODIMENT

A method and system for specific information retrieval that provides for a better handling of personalized queries are provided.

In one aspect, a computer-implemented information retrieval method is provided. The method includes extracting documents from a documents database with a data extractor; sending the extracted documents to a text management function; creating an indexed set of documents with an indexation function; storing and linking the indexed set of documents in an indexed documents database; receiving one or more user queries via a user interface at the text management function; enriching the queries via a query enrichment function; forwarding the enriched queries to one or more searching functions; browsing the indexed documents database according to one or more query terms with the searching function; forwarding the documents to the documents database; classifying the documents via a classifying function; and/or providing the documents to the user interface which is configured to display the results to a user.

In another aspect, an information retrieval system is provided. The system includes a data extractor configured for extracting documents from a documents database and sending the extracted documents to a text management function; an indexation engine configured for creating an indexed set of documents; an indexed documents database configured for storing and linking the indexed set of documents; a text management function configured for receiving one or more user queries from a user interface; a query enrichment function configured for enriching the queries and forwarding the enriched queries to one or more searching functions, wherein the searching function is configured for browsing the indexed documents database according to one or more query terms and forwarding the documents to the documents database; and/or a classifying function configured for classifying the documents and providing the documents to the user interface which is configured to display the results to a user.

In yet another aspect, an information retrieval system is provided. The system includes a social enrichment function configured for enhancing the representation of documents from the Web with social information; a social modeling function configured for modeling the documents from the Web in a personalized way at query time; and/or a document textual content indexer configured for keeping up to date the representation of documents as users contribute one or more types of social context.

Further scope of the applicability of the exemplary embodiment will become apparent from the detailed description provided below. It should be understood, however, that the detailed description and specific examples, while indicating preferred embodiments, are given by way of illustration only, since various changes and modifications within the spirit and scope of the exemplary embodiment will become apparent to those skilled in the art.

### DESCRIPTION OF THE DRAWINGS

The exemplary embodiment exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating social context of a Web page;

FIG. 2 is a block diagram of the overall architecture of an information retrieval process in accordance with aspects of the exemplary embodiment;

FIG. 3 is an illustration of folksonomy in accordance with aspects of the exemplary embodiment;

FIG. 4 shows user-tag matrices corresponding to the folksonomy of FIG. 3 in accordance with aspects of the exemplary embodiment;

FIG. 5 shows predicted missing values of the personal view matrices of FIG. 4; and

FIG. 6 is a description of an exemplary system in accordance with aspects of the exemplary embodiment.

### DETAILED DESCRIPTION

Referring now to the drawings wherein the showings are for purposes of illustrating the exemplary embodiments only and not for purposes of limiting the claimed subject matter, FIG. 1 is a block diagram illustrating the social context of a Web (or Internet) page (or document) 10 by a number of users 11. The social context of a document may be used to improve and personalize its representation for a Web search. Thus, the social context of a document on the Web (i.e., a Web page) can be: anchor text 12 that refers to it, a search query 14 associated with it, social annotations 16 associated with it, and the like. All of this social information can be easily used to improve document representation, since they provide good summaries for documents, e.g., document expansion. In particular, social information can be useful for documents that contain few terms where a simple indexing strategy is not expected to provide a good retrieval performance. In this regard, one example is the home page of Google, where there may be insufficient information on the page itself, but there are many annotations associated with it on a Web site such as Delicious.com.

The exemplary embodiment incorporates a Personalized Social Document View (PSDV) framework to improve document presentation using social information that come from social bookmarking systems. This framework delivers, for a given document, a different social representation for each user according to their understanding and the understanding of interesting users of this document. Further, the personalized social document view of a given document is used for a ranking purpose. Indeed, the exemplary embodiment further incorporates a ranking function for ranking documents with respect to a given query issued by a given user. This ranking function takes into account both the textual content of documents and their social context, i.e., their social representations.

A Social Web Search Engine maintains, for a given document, at least two index structures. The first index structure is based on the textual content of documents. The second index structure is based on the annotations related to documents as provided by a social bookmarking system. The goal is to improve the representation of documents. In this regard, it is noted that, on the one hand, with the advent of the social Web where all users are contributors, Web pages are associated with a social context that can tell us about their content. Eventually, the social information provided on these Web pages will be very useful for indexing, since it provides explicit user feedback. On the other hand, for the same document, users may have their own understanding of its content. Therefore, each user typically uses different words and vocabulary to describe, comment and annotate this document. For example, for the homepage of YouTube (http://www.youtube.com/), a given user can tag it with terms such as “video”, “Web” and “music,” while another can tag it with terms such as “news”, “movie” and “media.”

Taking into account these observations, enhancing document representation while personalizing it for each user with social information will improve Web searching.

The exemplary embodiment is connected to at least two fields: information retrieval and social networking. As shown in FIG. 2, the information retrieval process is composed of various steps, which include the processing of the user queries to results re-ranking via document indexing. Initially, a data extractor 202 extracts documents from a documents database 204 (step 206). The extracted documents are then sent to a text management function 208 (step 210). An indexation engine 212 creates an index (step 214). The indexed documents are then stored and linked in an indexed documents (or indexes) database 216 (step 218). Further, one or more user queries 220 are received by the user interface 222 and forwarded to the text management function 208 (step 224). The queries are enriched by a query enrichment function 226 (step 228). The enriched queries are forwarded to one or more searching functions 230 (step 232). The searching function 230 browses the indexed documents database 216 according to one or more query terms (step 234). The documents are then forwarded to the documents database 204 (step 236). The documents are classified by a classifying function 238 (step 240). The documents are then provided to the user interface 222 (step 242), which, in turn, displays the results to the user(s) (step 244).

In a search engine, the collections of documents stored on disk are usually referred to as the central repository. The content of these documents needs to be indexed using a data structure for fast retrieval and ranking, e.g., using an inverted index, which is probably the most used one due to its simplicity and effectiveness.

Social information can be used in various ways for indexing purposes. For instance, it can be used to uniformly enrich document content with social meta-data, e.g., document expansion. And it can be used to individually enhance document representation insofar as each user generally has their own vision of a given document. However, there is no contribution yet in personalized indexing using social.

The framework consists in representing a Web document in a dual-vector representation with (i) enhanced textual content and (ii) enhanced social content. These two components are used for ranking documents.

Initially, for ease of reference, the notation used in this document and the index structures is presented below. The framework of personalizing and enhancing document representation is then described. Finally, the exemplary method for ranking documents that match queries using Personalized Social Document View (PSDV) is described.

### NOTATION AND DEFINITIONS

As used herein, uppercase letters are used to denote matrices, and lowercase letters are used for vectors and scalars. The indices i and j are used to index rows and columns, respectively. Additional notation is defined below:
u, d, t: Respectively, the user u, the document d and the tag t.
   |A|: The number of element in the set A.
Tᵤ, T_{d}, T_{u,d}: respectively, the set of: tags used by u, tags used to annotate d, and tags used by u to annotate d.
Dᵤ, Dₜ, D_{u,t}: respectively, the set of: documents tagged by u, documents tagged with t, and documents tagged by u with t.
Uₜ, U_{d}, U_{t,d}: Respectively, the set of: users that use t, users that annotate d, and users that used t to annotate d.
M^{d}_{U,T}: The User-Tag matrix associated with the document d as described further.
M^{d}_{U}, M^{d}_{T}: Respectively, the user latent feature space matrix, and the tag latent feature space matrix associated with the document d, as described later.
∥.∥^{F}₂: denotes the Frobenius norm, where

$${‖ . ‖}_{F} = \sqrt{{\sum }_{i = 1}^{m} {\sum }_{j = 1}^{n} {\vert {a}_{ij} \vert}^{2}} . \qquad ( 1 )$$

### Index Structures

The exemplary approach maintains the following two index structures, i.e., a textual-content-based index and a social-based index (see FIG. 6).

With regard to the textual-content-based index, the collections of documents are indexed using the inverted index structure. An inverted index is an index data structure storing a mapping from an index term, i.e., m words, to its locations in the documents collection.

As for the social-based index, this structure is based on annotations assigned by users to documents in Social bookmarking Web sites, such as Delicious.com (formerly del.icio.us), which is a social bookmarking Web service for storing, sharing, and discovering Web bookmarks. Social bookmarking Web sites, also called folksonomies, are based on the techniques of social tagging or collaborative tagging. The principle behind social bookmarking platforms is to provide the user with a means to annotate resources on the Web, e.g., URIs in Delicious.com. These bookmarks (also called tags) can be shared with others. From an information retrieval perspective, this tagging operation is seen as a manual indexing task.

The tool adopts the Vector Space Model (VSM). Hence, queries and the textual representation of documents are mapped to be vectors in a universal term space to represent documents. The vectors of that represent the textual content of documents are weighted using the term-frequency, inverse document frequency (tf-idf).

### PSDV: A Framework for Personalized Social Document View

The framework of the Personalized Social Document View may be demonstrated using a simple, but illustrative, toy example. The low-rank matrix factorization method for enhancing and personalizing document representation is then introduced.

a. Toy Example:

Reference is now made to the typical folksonomy in FIG. 3. In this example, there are two users (e.g., Alice 310 and Bob 312) that annotate a number of resources (e.g., youtube.com 314, dailymotion.com 316, and aljazeera.com 318) using a number of tags (e.g., news 320, video 322, and Web 324).

As illustrated in FIG. 4, each document d can be represented via an m×n User-Tag matrix M^{d}_{U,T} of m user and n tags, where wᵢⱼ represents the extent to which the user uᵢ believes that the term tj is associated with the document d. For example, in this folksnomy, the user Bob believes that the term video has a weight of 0.54 in the Web page Youtube.com.

At this point, each document can be represented differently according to the point of view of the users that annotate it (users that almost have annotated it once). For example, Youtube.com may be represented using (video=0.54, Web=0.54) according to Alice, while it may be represented using (new=0.28) according to Bob. Starting from the observation that a user is on average expected to use few terms to annotate a document, and knowing that the distribution of documents over users follow a power low distribution in folksonomies, it is possible to apply a matrix factorization technique to enhance the personal view of a given document for a given user.

Thus, a method of predicting the missing values of the User-Tag matrix effectively and efficiently is provided. This technique is based on the reuse of other user experience in order to predict these missing values. The idea is to factorize the User-Tag matrix M^{d}_{U,T} of a document d using M^{d}_{U}M^{d}_{T}, where the low-dimensional matrix M^{d}_{U} denotes the user latent feature space, and M^{d}_{T} represents the low-dimensional tag latent feature space. For example, by using five dimensions to perform the matrix factorization for weighting prediction, the following 5-dimensional matrices are obtained:

$${M}_{U}^{′ d} = [ \begin{matrix}0.29 & 0.31 & 0.37 & 0.41 & 0.44 \\ 0.12 & 0.11 & 0.3 & 0.33 & 0.35\end{matrix} ]$$

$${M}_{T}^{d} = [ \begin{matrix}0.11 & 0.15 & 0.17 \\ 0.05 & 0.23 & 0.36 \\ 0.13 & 0.29 & 0.25 \\ 0.31 & 0.40 & 0.28 \\ 0.31 & 0.34 & 0.38\end{matrix} ]$$

where M^{d}ui and M^{d}ₜⱼ are the column vectors and denote the latent feature vectors of user uᵢ and tag tⱼ for the document d, respectively. It is then possible to predict the missing value wᵢⱼ in FIG. 4 using M′^{d}ui M^{d}ₜⱼ. Therefore, all the missing values can be predicted using 5-dimensional matrices M^{d}_{U} and M^{d}_{T}, as shown in FIG. 5. This method of low-rank matrix factorization is detailed further. Each row i of the predicted matrix M^{d}_{U}M^{d}_{T} represents the personal view of the ith user according to the document d. It is noted that even though user Alice does not annotate the Web page aldjazeera.com, this approach still can predict reasonable weighting. Also, it is further mentioned that the solutions of M^{d}_{U} and M^{d}_{T} are not necessarily unique.
b. Estimating the User-Tag Matrix

Initially, the construction of the User-Tag matrix M^{d}_{U,T} associated with a document d is described and the process for weighting it is described.

1. Constructing the User-Tag Matrix

The method of matrix factorization depends on at least two parameters: (a) the number of non-zero entries in the User-Tag matrix; and (b) the number of dimensions with which the factorization is performed. The highest are these parameters; the biggest is the matrix factorization complexity. Starting from here, and knowing that the framework should be executed on the fly, a series of measures may be employed to reduce the size of the User-Tag matrix for an effective, efficient, and fast factorization. For a given document d, certain restrictions may be established, including, but not limited to, the following:

Consider only the top k of users in the set U_{d} for the row dimension of M^{d}_{U, T}, sorted using:

$$Rank ( u ) = log ( \frac{\vert D \vert}{\vert {D}_{u} \vert} ) \times \frac{\vert {T}_{u , d} \vert}{\vert {T}_{d} \vert} \times sim ( u , {u}_{q} ) \qquad ( 2 )$$

where u_{q} is the user who requirt the social view, and sim can be any statistical similarity measure like the Jaccard, the Dice, the Ovelap, etc.

Consider only the set of tags T_{d} of the above top k users.

Finally, to extract the personal view of a user u who is not in the top k, simply add the user as a new entry in M^{d}_{U,T}.

These restrictions aim at filtering out users who are not interesting to the querier user and who represent noises, i.e., users who have annotated (i) improperly a lot of documents or (ii) the considered document with few terms.

2. Weighting of the User-Tag Matrix

As explained above, the framework relies on its ability to compute for a given document d, an m×n User-Tag matrix of m user and n tags, where wᵢⱼ represents the extent to which the user uᵢ believes that the term tⱼ is associated with the document d. The next step is to effectively estimate the personal weight of a tag tⱼ in a document d, according to a user uᵢ. One approach is simply to define wᵢⱼ as the user term frequency (utf), i.e., the number of times the user has used tⱼ normalized to give a measure of the importance of the term tᵢ regarding the overall tags that they used to annotate d. Thus, the user term frequency may be defined as follows:

$${utf}_{{u}_{i} , {t}_{j}}^{d} = \frac{{n}_{{u}_{i} , {t}_{j}}^{d}}{\vert {T}_{{u}_{i} , d} \vert} \qquad ( 3 )$$

At this stage, weighting the User-Tag matrix with only the user term frequency is not enough due to the existence of specialized folksonomies, e.g., Flickr for images, last.fm for sharing music, CiteULike for sharing research papers, etc. For example, users are expected to tag resources with the tag “music” on last.fm, or with the tag “research” on CiteULike. Therefore, sharing a very popular tag may signal a weak association and does not really highlight the interest to the user. Thus, it may be helpful to define the inverse user frequency (iuf), a measure to estimate the general importance of a term, which is computed as follows:

$${idf}_{{t}_{i} , {u}_{i}} = log ( \frac{\vert {D}_{{u}_{i}} \vert + 1}{\vert {D}_{{u}_{i} , {t}_{i}} \vert} ) \qquad ( 4 )$$

Finally, define the weight wᵢⱼ of the User-Tag matrix that represents the extent to which the user uᵢ believes that the term tⱼ is associated with the document d as the user term frequency, inverse document frequency (utf-iuf), which is computed by merging the two previous equations as follows:

wᵢⱼ=utf−idf=utfᵤ_{ᵢ}_{,t}_{ⱼ}^{d}×idfᵤ_{ᵢ}_{,t}_{ⱼ} (5)

A high weight in utf-idf is reached by a high user term frequency and a low document frequency of the term in the whole set of documents tagged by the user. The weights therefore tend to filter out terms commonly used by a user. Note that it is preferable to perform a stemming on the tags before computing the matrices, to eliminate the differences between terms having the same root to better estimate the weight of each term.

c. Low-Rank Matrix Factorization

An efficient and effective approach to predict missing values in the User-Tag matrix of personal views of a given document dᵢ is to factorize it, and then utilize the factorized user-specific and tag-specific matrices to make further missing data prediction. The premise behind a low-dimensional factor model is that there is only a small number of factors influencing the interest and that a user's interest vector is determined by how each factor applies to that user.

Consider an m×n User-Tag matrix M^{d}_{U,T} describing m users' view(s) of n tags according to a document dᵢ. A low-rank matrix factorization approach seeks to approximate the User-Tags matrix M^{d}_{U,T} by a multiplication of I-rank factors, as follow:

M^{d}_{U,T}≈M′_{U}^{d}×M_{T}^{d} (6)

where M^{d}_{U} εR^{l×m} and M^{d}_{T} εR^{l×n}. Since in the real world, each user only tags document with few tags, the User-Tag matrix M^{d}_{U,T} is usually extremely sparse. Thus, the User-Tag matrix of a given document M^{d}_{U,T} can be approximated using Singular Value Decomposition (SVD) by minimizing the sum-of-squared-error objective. However, since M^{d}_{U,T} contains a large number of missing values, it is only necessary to factorize the observed User-Tag matrix entries as follows:

$$arg {min}_{{M}_{U}^{d} \times {M}_{T}^{d}} \frac{1}{2} {\sum }_{i = 1}^{m} {\sum }_{j = 1}^{n} {{I}_{ij} ( {M}_{{u}_{i} , {t}_{j}}^{d} - {M}_{{u}_{i}}^{′ d} \times {M}_{{t}_{j}}^{d} )}^{2} \qquad ( 7 )$$

where Iᵢⱼ is the indicator function that is equal to 1 if user uᵢ used the tag tⱼ to annotate the document dᵢ and equal to 0 otherwise. In order to avoid overfitting and to constrain the objective function above, two regularization terms are added. Therefore, the objective function becomes:

$$arg {min}_{{M}_{U}^{d} \times {M}_{T}^{d}} \frac{1}{2} {\sum }_{i = 1}^{m} {\sum }_{j = 1}^{n} {{I}_{ij} ( {M}_{{u}_{i} , {t}_{j}}^{d} - {M}_{{u}_{i}}^{′ d} \times {M}_{{t}_{j}}^{d} )}^{2} + \frac{λ}{2} ( {‖ {M}_{U}^{d} ‖}_{F}^{2} + {‖ {M}_{T}^{d} ‖}_{F}^{2} ) \qquad ( 8 )$$

where λ>0. This optimization problem minimizes the sum-of-squared-errors objective function with quadratic regularization terms. Gradient based approaches can be applied to find a local minimum while we have:

$$\frac{\partial L}{\partial {M}_{{u}_{i}}^{d}} = {\sum }_{j = 1}^{n} {I}_{ij} ( {M}_{{u}_{i}}^{′ d} \times {M}_{{t}_{j}}^{d} - {M}_{{u}_{i} , {t}_{j}}^{d} ) \times {M}_{{t}_{j}}^{d} + λ {M}_{{u}_{i}}^{′ d} \\ \frac{\partial L}{\partial {M}_{{t}_{j}}^{d}} = {\sum }_{i = 1}^{m} {I}_{ij} ( {M}_{{u}_{i}}^{′ d} \times {M}_{{t}_{j}}^{d} - {M}_{{u}_{i} , {t}_{j}}^{d} ) \times {M}_{{u}_{i}}^{d} + λ {M}_{{t}_{j}}^{′ d} \qquad ( 9 )$$

### Ranking Model:

In the classical non-personalized search engines, the relevance between a query and a document is assumed to be only decided by the similarity of term matching of the textual content of the document. However, relevance is actually relative for each user. Thus, only query term matching of the textual content of documents is not enough to generate satisfactory search results for various users.

In the Vector Space Model (VSM), all the queries and the documents are mapped to be vectors in a universal term space. The similarity between a query and a document is calculated through the cosine similarity between the query term vector and the document term vector.

Using the VSM model, it is possible to model the associations between the query and the personalized social view of a document using a social view space. Each dimension of the social view space represents a tag. The tags associated with the personalized social view of the documents and the queries are represented as vectors in this space. Further, define a term similarity measurement using the cosine function. For example, let S_{d,u}=(w₁, w₂, . . . , wᵢ) be the personalized social tags vector of the document d for the user u, where wᵢ is the weight of the ith dimension according to u. Similarly, let q=(w₁, w₂, . . . , wⱼ) be the term vector of the query. The term similarity between S_{u,d} and q is calculated as:

$$sim ( {\vec{S}}_{u , d} , \vec{q} ) = \frac{{\vec{S}}_{u , d} \cdot \vec{q}}{\vert {\vec{S}}_{u , d} \vert \times \vert \vec{q} \vert} \qquad ( 10 )$$

Based on the social view space, the following fundamental search assumption is made:

Assumption 1.

The rank of a document d in the resulting list when a user u issues a query q is determined by at least two aspects: (i) a term matching between q and the textual content of d and (ii) a term matching between q and the personalized social representation of d.

When a user u issues a query q, assume two search processes, a term matching process and a social view matching process. The term matching process calculates the similarity between q and the textual content of each document to generate a user unrelated ranked document list. The social view matching process calculates the similarity between the social view S_{d} of each document and the query q to generate a social related ranked document list. Then, a merge operation is conducted to generate a final ranked document list based on the two sub-ranked document lists. Ranking aggregation may be used to implement the merge operation using, for example, the Weighted Borda-Fuse (WBF) as follows:

Rank(u,q,d)=γ×sim(\vec{q},\vec{d})+(1−γ)×sim(\vec{q},\vec{S}_{u,d}) (11)

where Sim(q,d) is the value of the cosine matching between textual content of d and the query q, Sim(q,S_{u,d}) is the value of the cosine matching between the query q and the social view of d and γ is the weight that satisfies 0<γ<1.

The whole architecture is illustrated in FIG. 6. At a high level, the system includes three main components—a crawling process 602, an indexing process 604, and query-time components 606.

With respect to the crawling process 602, a Web crawler 608 receives data from the Web 609, and a social crawler 610 receives data from social book marking Web sites/services 611, such as Delicious.com.

With respect to the indexing process 604, a documents database 612 stores document collections and their social annotations. A social annotation indexer 614 indexes the collections of documents based on annotations assigned by users to documents in Social bookmarking Web sites, and a document textual content indexer 616 indexes the collections of documents using the inverted index structure.

The query-time components 606 include a social inverted index 618 and a textual inverted index 620. As noted above, crawled Web pages and their social annotations are stored into the documents repository 612. The two indexing engines (614, 616) are generally responsible for indexing and keeping up to date the following index structures, respectively: (1) a social based index structure 618, which is based on the crawled annotations assigned by users to Web pages in Social bookmarking Web sites; and (2) a textual content based index structure 620, which is based on indexing the collection of crawled documents using the inverted index structure.

The social-based index 618 includes the following seven main data storage structures (not shown):
1. A Docs storage structure stores Web pages identifications (IDs) (e.g., md5 hash of a Web page name), the number of tags and users associated to the Web page, as well as the offset in the Docs_Users posting list.
2. A Tags storage structure stores the tag ID (md5 hash of the tag text), the number of Web pages and users associated to the tag, and the offset in the Tags Docs posting list.
3. A Users storage structure stores the user id (md5 hash of the user username), the amount of Web pages and tags associated to the user, and the offset in the Users Tags posting list.
4. A Docs_Users storage structure stores the posting list of users for Webpages. In particular, for each Web page, this structure stores: the id of the user who tags this Web page, the amount of tags he has used to annotate this Web page, and the offset in the Bookmarks posting list.
5. A Tags_Docs storage structure stores the posting list of Web pages for tags. In particular, for each tag, this structure stores the id of the Web page which is tagged with this tag and the amount of users who have used this tag to annotate this Web page.
6. A Users_Tags storage structure stores the posting list of tags for users. In particular, for each user, this structure stores the ID of the tag used by this user and the amount of Web pages tagged by this user with this considered tag.
7. A Bookmarks storage structure stores the posting list of tags for a document and a user. In particular, for each unique pair of Web page and a user, this structure stores the ID of the tag used by this user to annotate this Web page.

A searchers component 622 includes a document search process 624, a Personalized Social Document View (PSDV) creator 626, and a retrieval and ranking process 628. The document search process 624 matches a user query to the social inverted index 618. That is, the document search process 624 retrieves indexed documents from the social inverted index 618 that include at least one of the user's query terms.

The PSDV creator 626 includes, for example, (1) a social enrichment function that enhances the representation of documents with social information and (2) a social modeling function that models documents in a personalized way at query time.

Finally, the retrieval and ranking process 628 ranks the documents and formats the documents for display (or presentation) to the user on an interface 630 for search queries and results.

The exemplary embodiment improves the index structure from a user perspective for information retrieval, improves document representation, helps prevent empty results, and/or provides personalized Web search results. The exemplary embodiment also provides a platform to leverage social information; an indexing mechanism that built the two structures related to documents; and exploits social information for information retrieval purpose.

The exemplary embodiment provides a number of benefits, including, but not limited to:
enhancing document representation for a better perception of their contents;
enhancing document representation with user feedback, i.e., information explicitly provided by users;
building a more meaningful index;
preventing poor indexing;
considering both textual content of documents and their social context;
bringing closer the information retrieval techniques to the evolution of the Web toward Web2.0;
providing a personalized document representation for personalized search; and
personalizing Web search results.

It is to be appreciated that, suitably, the methods and systems described herein may be embodied by a computer, or other digital processing device including a digital processor, such as a microprocessor, microcontroller, graphic processing unit (GPU), etc. and storage. In other embodiments, the systems and methods may be embodied by a server including a digital processor and including or having access to digital data storage, such server being suitably accessed via the Internet or a local area network, or by a smartphone including a digital processor and digital data storage, or so forth. The computer or other digital processing device suitably includes or is operatively connected with one or more user input devices, such as a keyboard, for receiving user input, and further includes, or is operatively connected with, one or more display devices. In other embodiments, the input for controlling the methods and systems is received from another program running previously to or concurrently with the methods and systems on the computer, or from a network connection, or so forth. Similarly, in other embodiments the output may serve as input to another program running subsequent to or concurrently with methods and systems on the computer, or may be transmitted via a network connection, or so forth.

Unless specifically stated otherwise, or as is otherwise apparent from the discussion, terms such as “processing” or “computing” or “calculating” or “determining” or “displaying” or “predicting” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

In some embodiments, the exemplary methods, discussed above, the system employing the same, and so forth, of the present application are embodied by a storage medium storing instructions executable (for example, by a digital processor) to implement the exemplary methods and/or systems. The storage medium may include, for example: a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth.

It is to further be appreciated that in connection with the particular exemplary embodiments presented herein certain structural and/or functional features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

Further, as used herein, a controller includes one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, a data bus, such as USB and I2C, and the like; a user input device includes one or more of a mouse, a keyboard, a touch screen display, one or more buttons, one or more switches, one or more toggles, and the like; and a display includes one or more of a LCD display, an LED display, a plasma display, a projection display, a touch screen display, and the like.

The above description merely provides a disclosure of particular embodiments and is not intended for the purposes of limiting the same thereto. As such, the exemplary embodiment is not limited to only the above-described embodiments. Rather, it is recognized that one skilled in the art could conceive alternative embodiments that fall within the scope of the exemplary embodiment.

We claim:

1. A computer-implemented information retrieval method comprising:
extracting Web-based documents from a documents database with a data extractor;
sending the extracted documents to a text management function;
creating an indexed set of documents with an indexation function;
storing and linking the indexed set of documents in an indexed documents database;
receiving one or more user queries via a user interface at the text management function;
enriching the queries via a query enrichment function;
forwarding the enriched queries to one or more searching functions;
browsing the indexed documents database according to one or more query terms with the searching function;
forwarding the documents to the documents database;
classifying the documents via a classifying function; and
providing the documents to the user interface which is configured to display the results to a user.

2. The method of claim 1, wherein the documents include social context.

3. The method of claim 2, wherein the social context for a document includes one or more of anchor text that refers to the document, at least one search query associated with the document, and social annotations.

4. An information retrieval system comprising:
a data extractor configured for extracting documents from a documents database and sending the extracted documents to a text management function;
an indexation engine configured for creating an indexed set of documents;
an indexed documents database configured for storing and linking the indexed set of documents;
a text management function configured for receiving one or more user queries from a user interface;
a query enrichment function configured for enriching the queries and forwarding the enriched queries to one or more searching functions, wherein the searching function is configured for browsing the indexed documents database according to one or more query terms and forwarding the documents to the documents database; and
a classifying function configured for classifying the documents and providing the documents to the user interface which is configured to display the results to a user.

5. The system of claim 4, wherein the documents include social context.

6. The system of claim 5, wherein the social context for a document includes one or more of anchor text that refers to the document, at least one search query associated with the document, and social annotations.

7. An information retrieval system comprising:
a social enrichment function configured for enhancing the representation of documents from the Web with social context;
a social modeling function configured for modeling the documents from the Web in a personalized way at query time; and
a document textual content indexer configured for keeping up to date the representation of documents as users contribute one or more types of social context.

8. The system of claim 7, wherein the social context for a document includes one or more of anchor text that refers to the document, at least one search query associated with the document, and social annotations.

9. The system of claim 7, further comprising:
a documents collections database that stores document collections and their social annotations.

10. The system of claim 9, further comprising:
a social annotation indexer configured for indexing collections of documents stored in the documents collections database based at least on annotations assigned by users to documents on Social bookmarking Web sites and generating a social inverted index.

11. The system of claim 7, further comprising:
a searchers component includes a document search process and a retrieval and ranking process.

12. The system of claim 11, wherein the document search process is configured for retrieving indexed documents from a social inverted index that include at least one of a user's query terms.
